(19) United States
(12) Patent Application Publication
(10) Pub. No.: US 2009/0089251 A1
(43) Pub. Date: Apr. 2, 2009

(54) MULTIMODAL INTERFACE FOR SEARCHING MULTIMEDIA CONTENT

(76) Inventors: Michael James Johnston, New York, NY (US); Luis Fernando D'Haro, Madrid (ES); Michelle F. Levine, New York, NY (US); Bernard S. Renger, New Providence, NJ (US)

Correspondence Address: AT&T Legal Department - JW;Attn: Patent Docketing, Room 2A-207, One AT&T Way, Bedminster, NJ, 07921, US

(21) Appl. No.: 11/866,323

(22) Filed: Oct. 2, 2007

(51) Int. Cl. G06F 17/30

(52) U.S. Cl. 707/3; 707/E17.014

(57) ABSTRACT

A disclosed method and computer program product for searching a multimedia content database include determining a first query parameter provided by a user via a first input modality and optionally determining a second query parameter provided the user via a second input modality. A multidimensional query is generated where the query is indicative of the first and second query parameters. The query is applied to the multimedia content database to retrieve records of matching content. The retrieved records are then displayed to the user. The user may refine the query results using additional multidimensional and multimodal queries.

### BACKGROUND

1. Field

The disclosed subject matter is in the field of information networks and, more particularly information networks for provisioning television services.

2. Related Art

The amount of multimedia content available through subscription television services and movies-on-demand services is increasing rapidly and, as a result, it is becoming increasingly difficult for subscribers to locate and access the content that they want. In deployed networks including networks that include digital cable set top boxes, satellite receivers, or personal video recorders, the conventional methods of accessing multimedia content include manipulating an onscreen graphical user interface using a handheld infrared or radio frequency remote control device. To find content in such an environment, a user clicks through hierarchical menus or has to spell out titles or other search terms using an onscreen keyboard or in some cases using triple tap input on the remote control. These interfaces are already cumbersome and, as the amount of content increases, the limitations of these interfaces will only become more apparent. In many cases, users may never actually find what they want even if it is available.

### BRIEF DESCRIPTION OF THE DRAWINGS

The disclosed subject matter is illustrated by way of example and is not limited by the accompanying figures, in which like references indicate similar elements. Elements in the figures are illustrated for simplicity and clarity and have not necessarily been drawn to scale.

FIG. 1 is a block diagram of selected elements of a multimedia content distribution network;

FIG. 2 is a block diagram of a set top box suitable for use in the network of FIG. 1;

FIG. 3 is a conceptual representation of selected software and data components of the set top box of FIG. 2;

FIG. 4 illustrates details of an embodiment of a multimodal search interface of FIG. 3;

FIG. 5 is a flow diagram of an embodiment of a method of searching or querying a multimedia content database;

FIG. 6 is a conceptual representation of a process of searching a multimedia content database and refining search results; and

FIG. 7 is a representation of an exemplary screen for displaying multimedia content database search results.

### DETAILED DESCRIPTION

Distribution of multimedia content, including television and video on-demand content, via a wide area network encompassing multiple subscribers or end users is well known. Some multimedia distribution networks including, for example traditional coaxial-based “cable” networks, continuously distribute or “push” a composite signal that includes all or a large number of the channels offered. The different channels are modulated onto corresponding frequency bandwidths within the composite signal. A tuner within a set top box, television, or other receiver selects a channel from the composite signal to play or record. Many of these composite signal networks are largely unidirectional and highly proprietary.

In contrast to composite signal networks, other networks including, for example, Internet Protocol Television (IPTV) systems may distribute one or a relatively small number of channels to a user at any given time based on the needs of the user. As suggested by their name, IPTV networks leverage pervasive network technologies, standards, and infrastructure including, to some extent the Internet and the Internet Protocol (IP). In some IPTV networks, content is provided to the user over a physical connection that includes the “local loop” or “last mile” of a conventional telephone system. In these implementations, a subscriber's telephone lines may be used in combination with a residential gateway (RG), and a digital subscriber line (DSL) modem to provide basic network communication functionality. A set top box (STB) or other similar device connected to the RG provides functionality needed to decode video streams provided via the network and format resulting contents for display on a digital television, monitor, or other similar display device.

The inherent bidirectionality and the pervasiveness of the network technologies underlying IPTV offer the prospect of greater interactivity and a more flexible, extensible, and diverse set of features. IPTV networks are particularly suited for deploying network based applications and features.

In one aspect, a method and computer program product for searching a multimedia content database are disclosed. The disclosed method includes determining a first query parameter provided by a user via a first input modality and optionally determining a second query parameter provided by the user via a second input modality. A multidimensional query is generated where the query is indicative of the first and second query parameters. The query is applied to the multimedia content database to retrieve records of matching content. The retrieved records are then displayed to the user. The user may refine the query results using additional multidimensional and multimodal queries. The different modalities may also be used to cooperatively specify a single search parameter. Thus, for example, a first input modality might be used together with a second input modality to specify a search parameter.

In another aspect, a set top box for use in a multimedia content distribution network includes a controller and storage accessible to the controller. The set top box further includes a first interface for receiving user input via a first input modality, e.g., speech, handwriting, or remote control input, and a second interface for receiving user input via a second input modality. The set top box includes software modules including a module to integrate a first parameter specified via the first input modality with a second parameter specified via the second input modality to generate a query and a module to apply the query to a multimedia content database to extract records from the database and a display module to present the extracted records to the user.

In the following description, details are set forth by way of example to provide a thorough explanation of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 102-1 refers to an instance of a widget class, which may be referred collectively as widgets 102 and any one of which may be referred to generically as a widget 102.

Before describing details of applications, disclosed herein, for use in conjunction with a multimedia content distribution network, selected aspects of the network and selected devices used to implement the network are described to provide context for at least some implementations. Although a particular implementation of a multimedia content distribution network are depicted and described, the multimodal search functionality described herein is applicable to other environments. For example, the search functionality described may be implemented as a “front end” for finding multimedia content directly over a public network such as the Internet without implicating a set top box and other hardware described with respect to the depicted embodiment.

Television programs, video on demand, radio programs including music programs, and a variety of other types of multimedia content may be distributed to multiple subscribers over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a relatively large number of multimedia content channels (also referred to herein as “channels”), each occupying a different frequency band or channel, through a coaxial cable, a fiber-optic cable, or a combination of the two. The enormous bandwidth required to transport simultaneously large numbers of multimedia channels is a source of constant challenge for cable-based providers. In these types of networks, a tuner within a STB, television, or other form of receiver, is required to select a channel from the mixed signal for playing or recording. A subscriber wishing to play or record multiple channels typically needs to have distinct tuners for each desired channel. This is an inherent limitation of cable networks and other mixed signal networks.

In contrast to mixed signal networks, IPTV (Internet Protocol Television) networks generally distribute content to a subscriber only in response to a subscriber request so that, at any given time, the number of content channels being provided to a subscriber is relatively small, e.g., one channel for each operating television plus possibly one or two channels for recording. As suggested by the name, IPTV networks typically employ Internet Protocol (IP) and other open, mature, and pervasive networking technologies. Instead of being associated with a particular frequency band, an IPTV television program, movie, or other form of multimedia content is a packet-based stream that corresponds to a particular network address, e.g., an IP address. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an IP or analogous type of network address that is associated with the desired channel.

IPTV may be implemented, at least in part, over existing infrastructure including, for example, existing telephone lines, possibly in combination with customer premise equipment (CPE) including, for example, a digital subscriber line (DSL) modem in communication with a set top box (STB), a display, and other appropriate equipment to receive multimedia content from a network and convert such content into usable form. In some implementations, a core portion of an IPTV network is implemented with fiber optic cables while the so-called last mile may include conventional unshielded twisted pair copper cables.

IPTV networks support bidirectional (i.e., two-way) communication between a subscriber's CPE and a service provider's equipment. Bidirectional communication allows a service provider to deploy advanced features, such as video-on-demand (VoD), pay-per-view, advanced programming information including sophisticated and customizable programming guides, and the like. Bidirectional networks may also enable a service provider to collect information related to a subscriber's preferences, whether for purposes of providing preference based features to the subscriber, providing potentially valuable information to service providers, or potentially lucrative information to content providers and others.

Because they are rooted in historically computer-based networking, IPTV networks are generally more adept at offering features that extend traditional television including, for example, networked interactive gaming and other network hosted applications.

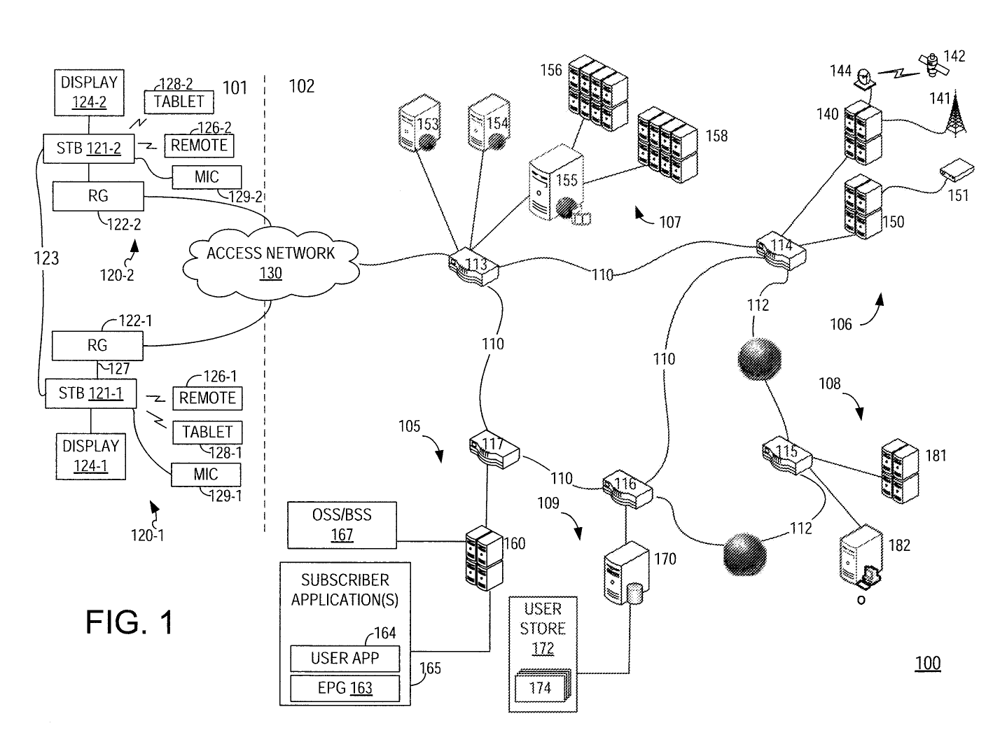

Referring now to the drawings, FIG. 1 illustrates selected aspects of an embodiment of a multimedia content distribution network (MCDN) 100. MCDN 100 as shown may be generally divided into a client side 101 and a service provider side 102, sometimes also referred to simply as a server side, 102. The client side 101 includes all or most of the resources depicted to the left of access network 130 while the server side encompasses the remainder.

Client side 101 and server side 102 are linked by access network 130. In embodiments of MCDN 100 that leverage telephony hardware and infrastructure, access network 130 may include the “local loop” or “last mile,” which refers to the physical wires that connect a subscriber's home or business to a local exchange. In these embodiments, the physical layer of access network 130 may include twisted pair copper cables or fiber optics cables employed either as fiber to the curb (FTTC) or fiber to the home (FTTH).

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

In other embodiments, access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on private network 110 and access network 130.

Services provided by the server side resources as shown in FIG. 1 may be distributed over a private network 110. In some embodiments, private network 110 is referred to as a “core network.” In at least some of these embodiments, private network 110 includes a fiber optic wide area network (WAN), referred to herein as the fiber backbone, and one or more video hub offices (VHOs). In large scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements from local entities. The regional VHOs may then deliver the local and national content for reception by subscribers served by the regional VHO. The hierarchical arrangement of VHOs, in addition to facilitating localized or regionalized content provisioning, may conserve scarce and valuable bandwidth by limiting the content that is transmitted over the core network and injecting regional content “downstream” from the core network.

Segments of private network 110 as shown in FIG. 1 are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an applications switch 117. In addition to providing routing/switching functionality, switches 113 through 117 preferably include hardware or firmware firewalls, not depicted, that maintain the security and privacy of network 110. Other portions of MCDN 100 communicate over a public network 112, including, for example, the Internet or other type of web-network where the public network 112 is signified in FIG. 1 by the world wide web icon.

As shown in FIG. 1, the client side 101 of MCDN 100 depicts two of a potentially large number of client side resources referred to herein simply as client(s) 120. Each client 120 as shown includes an STB 121, an RG 122, a display 124, and a remote control device 126. In the depicted embodiment, STB 121 communicates with server side devices through access network 130 via RG 122.

RG 122 may include elements of a broadband modem such as a DSL modem, as well as elements of a router and/or access point for an Ethernet or other suitable local area network (LAN) 127. In this embodiment, STB 121 is a uniquely addressable Ethernet compliant device. In some embodiments, display 124 may be any NTSC and/or PAL compliant display device. Both STB 121 and display 124 may, but do not necessarily include any form of conventional frequency tuner.

Remote control device 126 communicates wirelessly with STB 121 using an infra red (IR) or RF signal. IR-based remote control devices are economical but limited to line of sight operation whereas RF-based remote control devices are omni-directional, but more expensive to implement and more demanding in terms of power consumption, which is an important consideration for a battery based device.

The depicted embodiment of client 120 is suitable for supporting multimodal input from a user or subscriber. To enable multimodal communication, the depicted embodiment of client 120 includes an optional tablet device or, more simply, tablet 128 and a microphone 129. In some embodiments, tablet 128 is a portable, PC-based data processing device that interfaces with STB 121. Tablet 128 preferably includes hardware and/or software modules that support handwriting recognition that is capable of recognizing input that a user writes by hand, on a display screen of the tablet using a stylus or other form of non-marking pen. Tablet 128 may include elements similar to handwriting recognition modules available in commercially distributed tablet PC operating systems including, as an example, the Windows® XP Tablet PC Edition 2005 from Microsoft. Tablet 128 may communicate with STB 121 via a wireless or wired interconnection. In some embodiments, for example, STB 121 includes a wireless LAN (802.11 family) interface as well as a Bluetooth® or other personal area network (PAN) interface. In these embodiments, tablet 128 may communicate with STB 121 via either of these wireless interfaces or via another suitable wired or wireless interface. Similarly, client 120 as shown in FIG. 1 includes a microphone 129-2 shown in wired connection with STB 121. In some embodiments, the wired connection between microphone 129 and STB 121 may be universal serial bus (USB) connection or another standard connection. In these embodiments, microphone 129 may include elements of commercially distributed USB microphones including, for example, the Snowball microphone from Blue Microphones. Although the depicted embodiment of client 120 includes a PC-based device such as tablet 128 in communication with STB 121 to facilitate a handwritten component of multimodal interfacing, tablet 128 is an optional enhancement to the multimodal interfacing provided through the combination of microphone 129, remote control device 126, and STB 121.

In IPTV compliant implementations of MCDN 100, the clients 120 are operable to receive packet-based multimedia streams from access network 130 and process the streams for presentation on display 124. In addition, clients 120 are network-aware systems that may facilitate bidirectional networked communications with server side 102 resources to facilitate network hosted services and features. Because clients 120 are operable to process multimedia content streams while simultaneously supporting more traditional web-like communications, clients 120 may support or comply with a variety of different types of network protocols including streaming protocols such as RDP (reliable datagram protocol) over UDP/IP (user datagram protocol/internet protocol) as well as more conventional web protocols such as HTTP (hypertext transport protocol) over TCP/IP (transport control protocol).

The server side 102 of MCDN 100 as depicted in FIG. 1 emphasizes network capabilities including application resources 105, which may or may not have access to database resources 109, content acquisition resources 106, content delivery resources 107, and OSS/BSS resources 108.

Before distributing multimedia content to subscribers, MCDN 100 must first obtain multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down linked signals transmitted by a satellite 142 and received by a parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

As depicted in FIG. 1, content acquisition resources 106 include a video on demand (VoD) acquisition server 150. VoD acquisition server 150 receives content from one or more VoD sources that may be external to the MCDN 100 including, as examples, discs represented by a DVD player 151, or transmitted feeds (not shown). VoD acquisition server 150 may temporarily store multimedia content for transmission to a VoD delivery server 158 in communication with client-facing switch 113.

After acquiring multimedia content, acquisition resources 106 may transmit acquired content over private network 110, for example, to one or more servers in content delivery resources 107. Prior to transmission, live acquisition server 140 may encode acquired content using, e.g., MPEG-2, H.263, a WMV (Windows Media Video) family codec, or another suitable video codec. Encoding acquired content is desirable to compress the acquired content to preserve network bandwidth and network storage resources and, optionally, to provide encryption for securing the content. VoD content acquired by VoD acquisition server 150 may be in a compressed format prior to acquisition and further compression or formatting prior to transmission may be unnecessary and/or optional.

Content delivery resources 107 as shown in FIG. 1 are in communication with private network 110 via client facing switch 113. In the depicted implementation, content delivery resources 107 include a content delivery server 155 in communication with a live or real-time content server 156 and a VoD delivery server 158. For purposes of this disclosure, the use of the term “live” or “real-time” in connection with content server 156 and multimedia content generally is intended primarily to distinguish the applicable content from the content provided by VoD delivery server 158. The content provided by a VoD server is sometimes referred to as time-shifted content to emphasize the ability to obtain and view VoD content substantially without regard to the time of day or day of week. Live content, in contrast, is only available for viewing during its scheduled time slot unless the content is recorded with a DVR or similar device.

Content delivery server 155, in conjunction with live content server 156 and VoD delivery server 158, responds to subscriber requests for content by providing the requested content to the subscriber. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content in one or more packet headers according to the network communication protocol stack in use. These data packets are then transmitted across a network to a receiver, e.g., STB 121 of client 120, where the content is parsed from individual packets and re-assembled into multimedia content suitable for processing by a set top box decoder.

Subscriber requests received by content delivery server 155 include an indication of content that is being requested. In some embodiments, this indication includes an IP address associated with the desired content. For example, a particular local broadcast television station may be associated with a particular channel and the feed for that channel may be associated with a particular IP address. When a subscriber wishes to view the station, the subscriber may interact with remote control 126 to send a signal to STB 121 indicating a request for the particular channel. When STB 121 responds to the remote control signal, the STB 121 changes to the requested channel by transmitting a request that includes an IP address associated with the desired channel to content delivery server 155.

Content delivery server 155 may respond to a request by making a streaming video signal accessible to the subscriber. Content delivery server 155 may employ unicast and broadcast techniques when making content available to a subscriber. In the case of multicast, content delivery server 155 employs a multicast protocol to deliver a single originating stream to multiple clients. When a new subscriber requests the content associated with a multicast stream, there is generally latency associated with updating the multicast information to reflect the new subscriber as a part of the multicast group. To avoid exposing this undesirable latency to the subscriber, content delivery server 155 may temporarily unicast a stream to the requesting subscriber. When the subscriber is ultimately enrolled in the multicast group, the unicast stream is terminated and the subscriber receives the multicast stream. Multicasting desirably reduces bandwidth consumption by reducing the number of streams that must be transmitted over the access network 130 to clients 120.

As illustrated in FIG. 1, a client-facing switch 113 provides a conduit between subscriber side 101, including client 120, and server side 102. Client-facing switch 113 as shown is so named because it connects directly to the client 120 via access network 130 and it provides the network connectivity of IPTV services to consumers' locations.

To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including, real-time transport protocol (RTP), real-time control protocol (RTCP), file transfer protocol (FTP), and real-time streaming protocol (RTSP), as examples.

In some embodiments, client-facing switch 113 routes multimedia content encapsulated into IP packets over access network 130. For example, an MPEG-2 transport stream may be sent, in which the transport stream consists of a series of 188 byte transport packets, for example. Client-facing switch 113 as shown is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153 and client gateway 153 may then allow such devices to access the private network 110 once the devices are authenticated or verified. Similarly, client gateway 153 may prevent unauthorized devices, such as hacker computers or stolen set top boxes, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167. OSS/BSS gateway 167 may transmit a query to the OSS/BSS server 181 via an OSS/BSS switch 115 that may be connected to a public network 112. Upon client gateway 153 confirming subscriber and/or billing information, client gateway 153 may allow STB 121 access to IPTV content, VoD content, and other services. If client gateway 153 cannot verify subscriber information for STB 121, for example, because it is connected to an unauthorized twisted pair or residential gateway, client gateway 153 may block transmissions to and from STB 121 beyond the private access network 130.

MCDN 100 as depicted includes application resources 105, which communicate with private network 110 via application switch 117. Application resources 105 as shown include an application server 160 operable to host or otherwise facilitate one or more subscriber applications 165 that may be made available to system subscribers. For example, subscriber applications 165 as shown include an electronic programming guide (EPG) application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a subscriber. User application 164 is illustrated in FIG. 1 to emphasize the ability to extend the network's capabilities by implementing a networked hosted application. Because the application resides on the network, it generally does not impose any significant requirements or imply any substantial modifications to the client 120 including the STB 121. In some instances, an STB 121 may require knowledge of a network address associated with user application 164, but STB 121 and the other components of client 120 are largely unaffected.

As shown in FIG. 1, a database switch 116 connected to applications switch 117 provides access to database resources 109. Database resources 109 includes a database server 170 that manages a system storage resource 172, also referred to herein as user store 172. User store 172 as shown includes one or more user profiles 174 where each user profile includes account information and may include preferences information that may be retrieved by applications executing on application server 160 including subscriber application 165.

MCDN 100 as shown includes an OSS/BSS resources 108 including an OSS/BSS switch 115. OSS/BSS switch 115 as shown facilitates communication between OSS/BSS resources 108 via public network 112. The OSS/BSS switch 115 is coupled to an OSS/BSS server 181 that hosts operations support services including remote management via a management server 182. OSS/BSS resources 108 may include a monitor server (not depicted) that monitors network devices within or coupled to MCDN 100 via, for example, a simple network management protocol (SNMP).

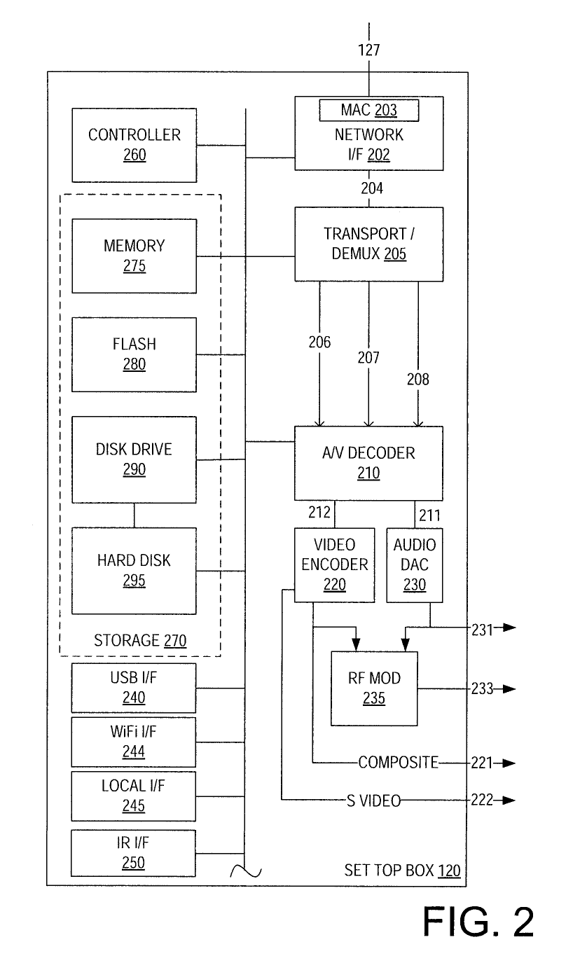

Turning now to FIG. 2, selected components of an embodiment of the STB 121 in the IPTV client 120 of FIG. 1 are illustrated. Regardless of the specific implementation, of which STB 121 as shown in FIG. 2 is but an example, an STB 121 suitable for use in an IPTV client includes hardware and/or software functionality to receive streaming multimedia data from an IP-based network and process the data to produce video and audio signals suitable for delivery to an NTSC, PAL, or other type of display 124. In addition, some embodiments of STB 121 may include resources to store multimedia content locally and resources to play back locally stored multimedia content.

In the embodiment depicted in FIG. 2, STB 121 includes a general purpose processing core represented as controller 260 in communication with various special purpose multimedia modules. These modules may include a transport/de-multiplexer module 205, an A/V decoder 210, a video encoder 220, an audio DAC 230, and an RF modulator 235. Although FIG. 2 depicts each of these modules discretely, STB 121 may be implemented with a system on chip (SoC) device that integrates controller 260 and each of these multimedia modules. In still other embodiments, STB 121 may include an embedded processor serving as controller 260 and at least some of the multimedia modules may be implemented with a general purpose digital signal processor (DSP) and supporting software.

Regardless of the implementation details of the multimedia processing hardware, STB 121 as shown in FIG. 2 includes a network interface 202 that enables STB 121 to communicate with an external network such as LAN 127. Network interface 202 may share many characteristics with conventional network interface cards (NICs) used in personal computer platforms. For embodiments in which LAN 127 is an Ethernet LAN, for example, network interface 202 implements level 1 (physical) and level 2 (data link) layers of a standard communication protocol stack by enabling access to the twisted pair or other form of physical network medium and supporting low level addressing using MAC addressing. In these embodiments, every network interface 202 includes a globally unique 48-bit MAC address 203 stored in a ROM or other persistent storage element of network interface 202. Similarly, at the other end of the LAN connection 127, RG 122 has a network interface (not depicted) with its own globally unique MAC address.

Network interface 202 may further include or support software or firmware providing one or more complete network communication protocol stacks. Where network interface 202 is tasked with receiving streaming multimedia communications, for example, network interface 202 may include a streaming video protocol stack such as an RTP/UDP stack. In these embodiments, network interface 202 is operable to receive a series of streaming multimedia packets and process them to generate a digital multimedia stream 204 that is provided to transport/demux 205.

The digital multimedia stream 204 is a sequence of digital information that includes interlaced audio data streams and video data streams. The video and audio data contained in digital multimedia stream 204 may be referred to as “in-band” data in reference to a particular frequency bandwidth that such data might have been transmitted in an RF transmission environment. Multimedia stream 204 may also include “out-of-band” data which might encompass any type of data that is not audio or video data, but may refer in particular to data that is useful to the provider of an IPTV service. This out-of-band data might include, for example, billing data, decryption data, and data enabling the IPTV service provider to manage IPTV client 120 remotely.

Transport/demux 205 as shown is operable to segregate and possibly decrypt the audio, video, and out-of-band data in digital multimedia stream 204. Transport/demux 205 outputs a digital audio stream 206, a digital video stream 207, and an out-of-band digital stream 208 to A/V decoder 210. Transport/demux 205 may also, in some embodiments, support or communicate with various peripheral interfaces of STB 121 including an IR interface 250 suitable for use with an IR remote control unit (not shown) and a front panel interface (not shown).

A/V decoder 210 processes digital audio, video, and out-of-band streams 206, 207, and 208 to produce a native format digital audio stream 211 and a native format digital video stream 212. A/V decoder 210 processing may include decompression of digital audio stream 206 and/or digital video stream 207, which are generally delivered to STB 121 as compressed data streams. In some embodiments, digital audio stream 206 and digital video stream 207 are MPEG compliant streams and, in these embodiments, A/V decoder 210 is an MPEG decoder.

The digital out-of-band stream 208 may include information about or associated with content provided through the audio and video streams. This information may include, for example, the title of a show, start and end broadcast times for the show, type or genre of the show, broadcast channel number associated with the show, original air date, and so forth. A/V decoder 210 may decode such out-of-band information. MPEG embodiments of A/V decoder 210 support a graphics plane as well as a video plane and at least some of the out-of-band information may be incorporated by A/V decoder 210 into its graphics plane and presented to the display 124, perhaps in response to a signal from a remote control device.

The native format digital audio stream 211 as shown in FIG. 2 is routed to an audio DAC 230 to produce an audio output signal 231. The native format digital video stream 212 is routed to an NTSC/PAL or other suitable video encoder 220, which generates digital video output signals suitable for presentation to an NTSC or PAL compliant display device 204. In the depicted embodiment, for example, video encoder 220 generates a composite video output signal 221 and an S video output signal 222. An RF modulator 235 receives the audio and composite video outputs signals 231 and 221 respectively and generates an RF output signal 221 suitable for providing to an analog input of display 204.

In addition to the multimedia modules described, STB 121 as shown includes various peripheral interfaces. STB 121 as shown includes, for example, a USB interface 240, a wireless LAN interface 244, also referred to as an 802.11 family interface and/or a WiFi interface, and a local interconnection interface 245. Local interconnection interface 245 may, in some embodiments, support the HPNA or other form of local interconnection 123 shown in FIG. 1. In an embodiment of STB 121 operable to support multimodal input, STB 121 uses the various I/O interfaces to provide and support connectivity to I/O devices including microphone 129 via USB interface 240, a tablet 128 via WiFi I/f 244, and a remote control 126 via IR I/F 250. In this embodiment, client 120 and STB 121 support speech input via microphone 129 via USB I/F 240, hand written input, text input, and point-and-click input via pen from tablet 128 and WiFi I/F 244, and GUI or navigation-based input using, e.g., arrow keys, via remote control 126 and IR I/F 250.

The illustrated embodiment of STB 121 includes storage resources 270 that are accessible to controller 260 and possibly one or more of the multimedia modules. Storage 270 may include DRAM or another type of volatile storage identified as memory 275 as well as various forms of persistent or nonvolatile storage including flash memory 280 and/or other suitable types of persistent memory devices including ROMs, EPROMs, and EEPROMs. In addition, the depicted embodiment of STB 121 includes a mass storage device in the form of one or more magnetic hard disks 295 supported by an IDE compliant or other type of disk drive 290. Embodiments of STB 121 employing mass storage devices may be operable to store content locally and play back stored content when desired.

Some embodiments emphasize a particular implementation of STB 121, in which an application that supports multimodal input in connection with a GUI or other form of interface that enables and supports multi-dimensional searching of multimedia content provided to a subscriber or other user via network 100.

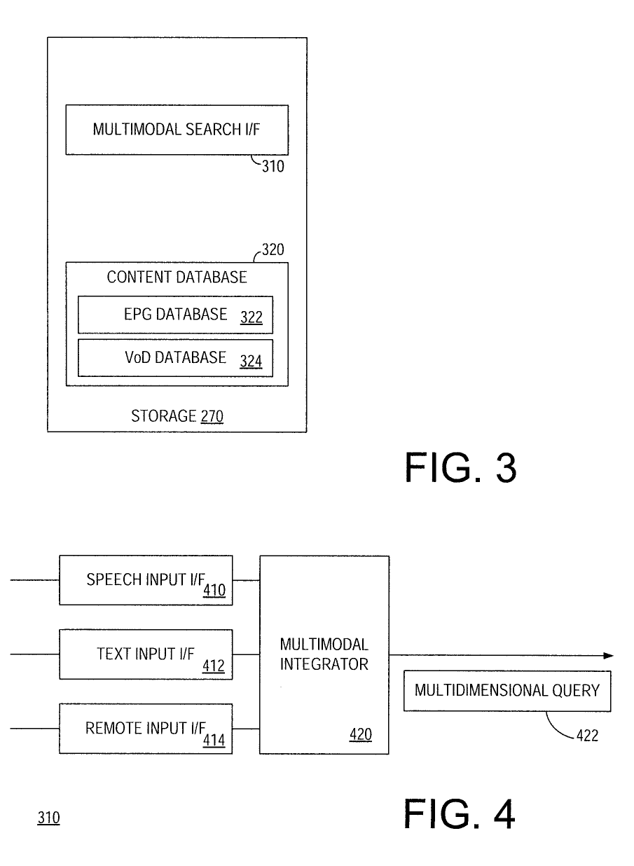

Referring to FIG. 3, a conceptual representation of selected software elements emphasizing multidimensional search functionality including multimodal input support is depicted. Although the described and depicted embodiments emphasize multidimensional searches, the multimodal input capability may be used to define a broader search including a one-dimensional search. The depicted software elements may be referred to herein as computer program products and may include a set of computer executable instructions, stored on or embedded within storage 270 or another computer readable medium of or accessible to STB 121. Thus, all or a portion of the software elements and data structures depicted as residing on STB 121 may be hosted on or served from a network-based storage resource such as a storage resource accessible to a network based application server such as application server 160 of FIG. 1. The content search components depicted in FIG. 3 include a module identified as multimodal search interface 310 and a data structure identified as a content database 320 which includes an electronic programming guide (EPG) database 322 and a video-on-demand database 324.

Content database 320 is a dynamic database that may be updated from time to time by STB 121. In one implementation, for example, EPG data for a specified time period is provided to a network-based server such as content delivery server 155, application server 160, or some other server within network 100. STB 121 may retrieve EPG data from the network 100 and store the data as EPG database 322. EPG database 322 may include time, date, channel, and description information for various live programs.

Content database 320 as shown in FIG. 3 further includes a VoD database 324. VoD database, as suggested by its name, includes information pertaining to VoD content. This information may include detailed information about the various multimedia programs or movies including information indicative of a program's or movie's title, genre or category, cast members and their roles, credited crew members (including director, producer, etc.), length, MPAA rating, aspect ratio, resolution (e.g., HD or SD), language information (e.g., English), year of release, plot synopsis or plot keywords, detailed plot descriptions, show time or time slot (e.g., 10:00 AM-11:00 AM), channel number, call sign, channel name, advisories, TV movie rating, Original Air Date, show type, close captioning, duration/runtime, date, TV program rating, repeat indicator (true or false), show type, cover art, stars, and any other suitable item of information.

Although the depicted embodiment indicates distancing data structures for EPG database 322 and VoD database 324, this implementation is not intended to be a limiting or mandatory feature of all embodiments. In some embodiments, EPG database 322 and VoD database 324 may be combined into unified content database 320.

Multimodal search interface 310 represents executable application code that is operable to receive multiple search parameters as inputs via one or more input modalities including, as examples, a speech modality, a handwritten modality, a text modality, a point-and-click modality, and a navigation-based or GUI modality. Multimodal search interface 310 is operable to integrate the search parameters provided via different search modalities into a unified or integrated query. The unified query may be in the form of an SQL query or other query that operates on content database 320. In some embodiments, the unified query is a multidimensional query that includes two or more parameters or characteristics by which the content database 320 is to be queried. In other embodiments, a multidimensional query may refer to a query that employs multiple input modalities to specify a single search parameter or criterion. Content database 310, for example, may include various records where each record includes or may be associated with a corresponding program or movie. Each record may include multiple fields that may correspond to parameters specified in the unified search. For example, the content database 320 may include records of movies where each record includes cast and crew fields indicating the cast and crew members for the corresponding movie or other item of content.

Turning now to FIG. 4, selected elements of an embodiment of multimodal search interface 310 are depicted. In the depicted embodiment, multimodal search interface 310 includes a speech input interface 410, a text input interface 412, and a remote control input interface 414, each of which is connected to a multimodal integrator 420. Speech input interface 410 receives input based on a speech modality including speech provided via microphone 129 and USB interface 240 as described above with respect to FIG. 1 and FIG. 2. In some embodiments, USB interface 240 produces a serialized bit stream that is representative of speech input from a speaker via microphone 129. In this embodiment, speech input interface 410 may be operable to provide a speech-to-text conversion of the bit stream received via USB interface 240 and provide the resulting text stream to multimodal integrator 420.

Similarly, text input interface 412 is operable to receive text-based input from tablet 128 and deliver the text-based input to multimedia integrator 420. Remote input interface 414 communicates with IR interface 250 to receive remote control commands from remote control device 126. The remote control commands may be converted to text strings by remote input interface 414 in some embodiments so that all of the inputs are converted to a common format regardless of the originating modality. In some embodiments that include the optional tablet 128, the pen or other input device for tablet 128 might be used to perform point-and-click selection in lieu of remote control 126.

Multimodal integrator 420 is operable to receive inputs from the depicted interfaces 410, 412, and 414. In the depicted embodiment, multimodal integrator 420 generates a multidimensional query that is submitted to content database 320 to search for multimedia content. In some embodiments, the inputs to multimodal integrator 420 from interfaces 410, 412, and 414 are in a common format, such as text. In other embodiments, the input from speech input interface 410 may be in a different format than the input from remote input interface 414. In these embodiments, multimodal integrator 420 is responsible for converting the inputs to a common format or operating on the inputs in their native formats. However, regardless of the format of the inputs it receives, multimodal integrator 420 is enabled to harmonize the aspects of a query emphasized by each of the various input sources. For example, speech input interface 410 may deliver information indicative of a first parameter of a multimedia content query and text input interface 412 and/or remote input interface 414 may deliver information indicative of a second parameter of the query. Multimodal integrator 420 is enabled to extract the applicable parameters from each of the input sources and generate a single query based on and reflecting the different parameters. In the depicted embodiment, the resulting query is labeled as a multidimensional query to emphasize embodiments in which multiple search parameters are specified via the various interfaces. For example, some embodiments emphasize the ability to define or indicate a first search parameter via a first input modality and a second search parameter via a second search parameter. In these embodiments, multimodal integrator 420 combines the various search parameters to create multidimensional query 422. In some embodiments, multimodal integrator 420 is operable to determine the relative chronological timing of the different input modalities. In these embodiments, multimodal integrator 420 may determine that two or more different input modalities are related to the same query because the inputs occur within a specified time window. Similarly, multimodal integrator 420 may treat different input modalities as being associated with different searches if the relative timing of the different inputs exceeds a specified timing threshold, i.e., are too far apart in time.

Thus, in some embodiments, multimodal search interface 310 is operable to accept or convey a first search parameter that is received or determined via a first input modality and accept or convey a second search parameter that is received or determined via a second input modality. In the context of a multimedia database 320 for example, the parameters that may be use to define a search may include, as exemplary but non-limiting examples, cast members, crew members including directors, producers, writers, cinematographers, and so forth, year of release, rating, e.g., MPAA rating, keywords related to the story plot, and technical information including, for example, the aspect ratio, and the resolution of the content, e.g., HD or SD.

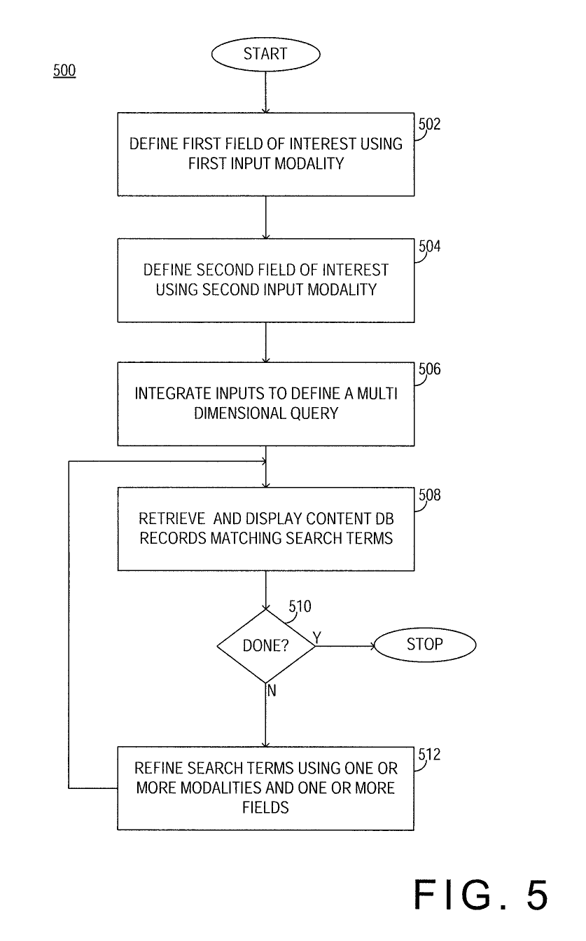

Turning to FIG. 5, a flow diagram illustrates selected elements of a computer program product for and a method of searching multimedia content using two or more input modalities to define the search terms. Computer program product embodiments, as indicated previously, include computer executable instructions, stored on a computer readable medium. When the instructions are executed by a processor, the processor affects the elements of the depicted flow diagram.

In the embodiment emphasized in FIG. 5, a first field of interest is defined (block 502) using a first input modality. The field of interest may correspond to a search query parameter. In some embodiments, the multimedia database includes records where each record has multiple fields. A record might, for example, represent a movie or program. In such cases, the fields may represent different parameters associated with the movie or program such as the cast members, crew members, and so forth as described previously. Thus, as an example, block 502 may include a user defining a first parameter of a search query by indicating an actor's name with the microphone 129, which would represent the first input modality, i.e., speech.

In block 504, the user defines a second field of interest using a second input modality. Here, for example, the user could define a second parameter of interest such as the year of release using handwritten input via tablet 128. The year of release might be specified as a specific year (e.g., 1986), a range of years (the '70s) or in a non-specific manner (e.g., recent).

In block 506, the search parameters defined in blocks 502 and 504 are integrated to define a multidimensional query 422. Integration of the various search parameters may include converting input parameters specified using different input modalities into a common mode or format such as text, for example. The integration in block 506 would also preferably include generating the multidimensional query using parameters and query formats compatible with the content database 320.

In block 508, the query 422 has been submitted to the content database 320 and the results of the query are retrieved and displayed. Specifically, the records that match the defined query are retrieved and displayed. If, for example, a query specifies all movies in which Actor A is a cast member and Director B directed the film, the retrieved records would include as such movies and/or programs.

The method and computer program product embodiment depicted in FIG. 5 includes the ability to refine search results as depicted in blocks 510 and 512. If, in block 510, a user either takes no action or determines that he/she is satisfied with the search results, the method is complete. If, however, the user wishes to refine the search results, FIG. 5 illustrates a block 512 in which the user may refine search terms using one or more input modalities and one or more fields of interest or parameters. Continuing with the previous example to illustrate the revision functionality, the search results returned in response to the first query may be presented to the user in a display interface that includes the ability to receive additional input including additional input defining additional or refining search terms. The user may then use this input element to define further constraints on the content of interest. The user might, for example, specify plot keywords, year of release, or an additional cast member to narrow the results generated by the first query. The user may then submit the revised query to return to block 508 to refine the results of the search. In this manner, the user may continue to edit and refine query terms until the user obtains the desired results. Moreover, at each revision iteration, the depicted embodiment enables the user to refine the input using any of the available input modalities.

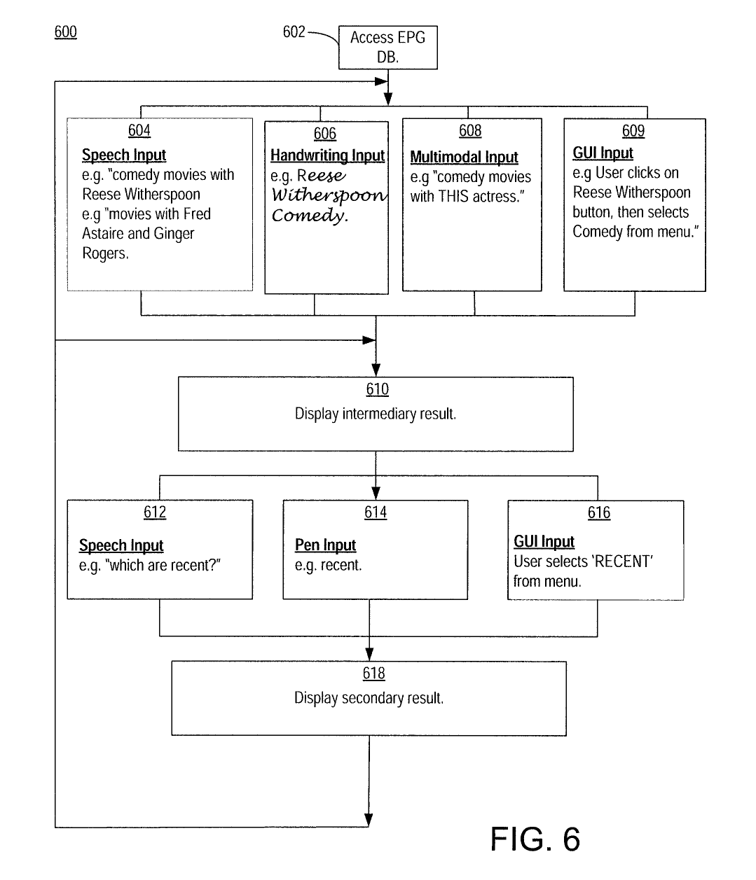

The described search and refine process is conceptually depicted in FIG. 6 wherein a search and refine process 600 is illustrated as including a first tier of search, represented by blocks 604 through 609 in which an initial query is defined by specifying one or more fields of interests or search parameters using one or more of the available input modalities. Thus, for example, FIG. 6 depicts various techniques for defining a first multidimensional query to identify content by genre, namely comedies, and actor, namely Reese Witherspoon. In blocks 604, 606, and 609, the multidimensional query is defined using a single input modality, namely, speech, handwriting, and remote input, respectively. In block 608, the multidimensional query is defined using multimodal inputs where the genre is specified by a speech modality and the actor is specified by a remote control input, i.e., clicking on the actor's name.

The results of the content retrieved in response to the first query is represented in block 610. At this point, the user may refine the results by defining a refining query as represented by blocks 612, 614, and 616 in which the user specifies a single additional query parameter, namely, year of release, by querying for “recent” films via speech, handwriting, or GUI input respectively. The refined results are displayed as represented in block 618. In this example, the refined or secondary results in block 618 would represent recent comedies in which Reese Witherspoon was a cast member. FIG. 6 as shown illustrates the iterative capability of the depicted embodiment with an arrow leading from secondary results display at block 618 to a search defining block 604, 606, 608, or 609. In this manner, the user may iteratively define and refine the content that is searched for. Moreover, at each iteration, the user may refine the search results by specifying multiple additional dimensions or search parameters using multiple input modalities.

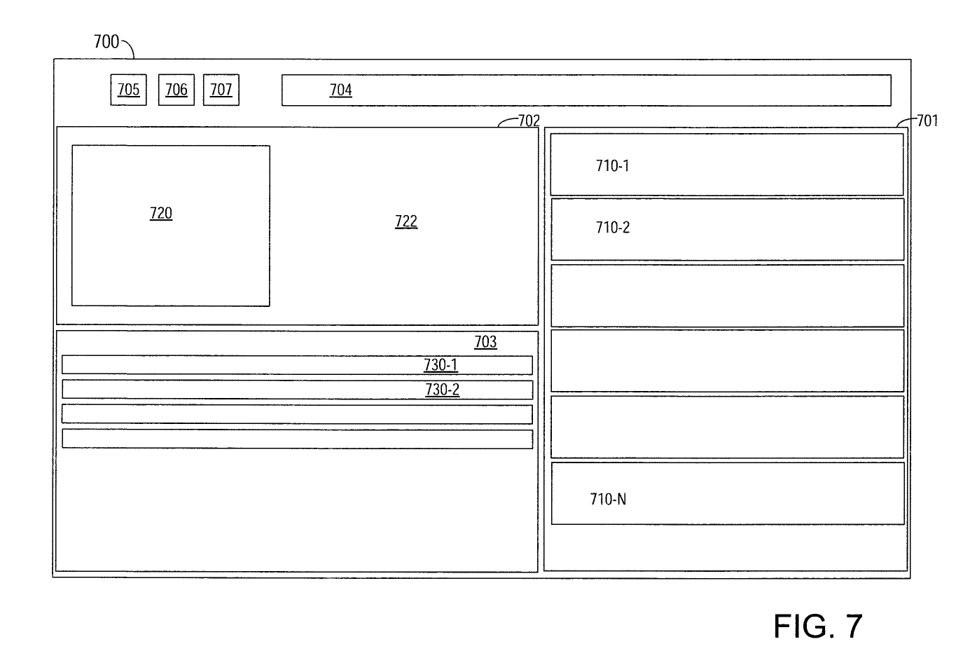

FIG. 7 is a conceptual representation of an exemplary display screen suitable for use in some embodiments of the content search techniques disclosed herein. As depicted in FIG. 7, a multimedia content search results screen 700 includes a first window 701, a second window 702, and a third window 703. The first window 701 may display a list of program or movies 710-1 through 710-N that match the submitted query terms. The second window 702 may include a still or moving image 720 corresponding to a program or movie 710 in first window 701. For example, the image 720 may correspond to the first listed program or movie 710-1 or to a program or movie 710 that has been selected or highlighted using a remote control. Adjacent to the image 720, the depicted embodiment of second window 702 may include a textual description 722 summarizing the corresponding program or movie and may include additional information including year of release, rating, starring cast member(s), and selected production members. Third window 703 includes a plurality of links 730. In some embodiments, each of the links 730 is derived from the selected movie or program displayed in second window 720. For example, third window 703 may include links 730 corresponding to all or some of the cast members of the movie or program featured in second window 702. In this embodiment, the user may use the remote control input to refine or alter a query based on actors that appeared in the featured movie or program. Similarly, third window 703 may include the name of the director, writer, and so forth to enable the user to refine an existing search or generate a new search.

Screen 700 as shown in FIG. 7 further includes an input box 704 suitable for receiving input to refine the search results presented in first window 701. Thus, for example, if the results 710 presented in first window 701 represent the results of a search requesting all Reese Witherspoon comedies, input box 704 may be employed to refine the search, for example, by requesting only recent films or films that included another specified actor and so forth. In some embodiments, input box 704 is suitable for receiving handwritten or text input from the optional tablet 128 or from a remote control 126, e.g., using triple tap input. In other embodiments, screen 700 may include additional buttons, three of which are shown as buttons 705, 706, 707. Buttons 705 through 707 may enable search refinement capabilities through a navigation based modality using remote control 126 for embodiments that might not include the optional tablet device or through point-and-click modality using an optional tablet 128. For example, button 705 might be presented to enable a user to refine the search results based on recency, i.e., year of release. Similarly, button 706 might enable search result refinement based on program rating, genre, or any other suitable parameter or criteria. Although FIG. 7 depicts three buttons 705 through 707 that enable navigation based or point-and-click search result refinement, other embodiments may employ more or fewer such buttons. Moreover, the search refinement buttons 705 through 707 may be user definable via a preferences menu or setting (not depicted) or may be dynamically created depending on previous queries.

The above disclosed subject matter is to be considered illustrative, and not restrictive, and the appended claims are intended to cover all such modifications, enhancements, and other embodiments which fall within the true spirit and scope of the disclosed subject matter. Thus, to the maximum extent allowed by law, the appended claims are entitled to the broadest permissible interpretation, and shall not be restricted or limited by the foregoing detailed description.

What is claimed is:

1. A computer program product comprising instructions, stored on a computer readable medium, for searching a multimedia content database, the instructions comprising instructions to:
determine a first query parameter provided by a user via a combination of a first input modality and a second input modality;
generate a query indicative of the first query parameter;
apply the query to a multimedia content database to extract records of matching content; and
display the matching content records.

2. The computer program product of claim 1, wherein a record in the multimedia content directory is associated with a plurality of fields and wherein the first query parameter corresponds to a first field.

3. The computer program product of claim 2, wherein the fields include a set of fields selected from the group of fields consisting of duration, rating, genre, actor, director, writer, producer, credited crew member, plot descriptions, plot keywords, release date, language, aspect ratio, resolution, channel, original air date, and scheduled broadcast time.

4. The computer program product of claim 1, wherein the first and second input modalities are selected from a group of modalities consisting of a spoken modality, a handwritten modality, a text input modality, a point-and-click modality, and a navigation based modality.

5. The computer program product of claim 1, further comprising ordering the matching content records and wherein displaying the matching content records comprises displaying the matching content in an ordered list based on the ordering.

6. The computer program product of claim 5, wherein the ordered list is displayed in a first display window, wherein the display includes a second display window containing a description of the first record in the ordered list.

7. The computer program product of claim 5, wherein the ordered list is displayed in a first display window, wherein the display includes a third display window displaying values of at least one field associated with the first record in the ordered list.

8. The computer program product of claim 7, wherein the matching content record corresponds to a program and wherein the third display window displays crew members credited in the program.

9. The computer program product of claim 8, wherein the third display window displays at least one of the credited actors as a selectable link, wherein the selectable link, when invoked, generates a secondary query using a credited actor associated with the selected link as a criteria.

10. A search service for use with a multimedia content database, the service comprising:
enabling a set top box to determine a first query parameter provided by a user via a first input modality;
enabling the set top box to determine a second query parameter provided the user via a second input modality;
enabling the set top box to generate a multidimensional query indicative of the first and second query parameters;
enabling the set top box to apply the multidimensional query to a multimedia content database to extract records of matching content; and
configuring the set top box to format and output the extracted display to a display device for display.

11. The service of claim 10, wherein a record in the multimedia content directory is associated with a plurality of fields and wherein the first query parameter corresponds to a first field and the second query parameter corresponds to a second field.

12. The service of claim 1 1, wherein the fields include a set of fields selected from the group of fields consisting of duration, rating, genre, actor, director, writer, producer, credited crew member, plot descriptions, plot keywords, release date, language, aspect ratio, resolution, channel, original air date, and scheduled broadcast time.

13. The service of claim 10, wherein the first and second input modalities are selected from a group of modalities consisting of consisting of a spoken modality, a handwritten modality, a text input modality, a point-and-click modality, and a navigation based modality.

14. The service of claim 10, further comprising ordering the matching content records and wherein displaying the matching content records comprises displaying the matching content in an ordered list based on the ordering.

15. The service of claim 14, wherein the ordered list is displayed in a first display window, wherein the display includes a second display window containing a description of the first record in the ordered list.

16. The service of claim 14, wherein the ordered list is displayed in a first display window, wherein the display includes a third display window displaying values of at least one field associated with the first record in the ordered list.

17. The service of claim 16, wherein the matching content record corresponds to a program and wherein the third display window displays actors credited in the program.

18. The service of claim 17, wherein the third display window displays at least one of the credited actors as a selectable link, wherein the selectable link, when invoked, generates a secondary query based on applicable credited actor.

19. A set top box for use in a multimedia content distribution network, the set top box including a controller and storage accessible to the controller, the set top box further comprising:
a first interface for receiving user input via a first input modality;
a second interface for receiving user input via a second input modality; and
wherein the storage includes controller executable modules including a module enabled to integrate a first parameter specified via the first input modality with a second parameter specified via the second input modality to generate a query and a module to apply the query to a multimedia content database to extract records from the database and a display module to present the extracted records to the user.

20. The set top box of claim 19, wherein the first and second modalities are selected from the group of modalities consisting of consisting of a spoken modality, a handwritten modality, a text input modality, a point-and-click modality, and a navigation based modality.
